(19) United States
(12) Patent Application Publication
(10) Pub. No.: US 2026/0330835 A1
(43) Pub. Date: Oct. 22, 2026

(54) VIDEO MONITORING SYSTEM AND METHOD FOR DISTRACTION DETECTION AND NOTIFICATION

(71) Applicant: 2hr Learning, Inc., Austin, TX (US)

(72) Inventors: Aashish Gaba, Bangalore (IN); Rohit Kumar, Delhi (IN); Siddhant Hirve, Bangalore (IN); Sirjanpreet Singh, Delhi (IN); BangaAbhishek Prusty, Bangalore (IN); Pedro Ricardo Gomes Dias, Hong Kong (CN); Pedro Ricardo Gomes Dias, Hong Kong (CN)

(73) Assignee: 2hr Learning, Inc., Austin, TX (US)

(21) Appl. No.: 19/177,465

(22) Filed: Apr. 11, 2025

Related U.S. Application Data
(60) Provisional application No. 63/632,979, filed on Apr. 11, 2024.

(51) Int. Cl. G06V 20/52; G06T 7/20; G06V 10/77; G06V 40/16

(52) U.S. Cl. CPC G06V 20/52; G06T 7/20; G06V 10/7715; G06V 40/172

(57) ABSTRACT

A video monitoring and distraction analysis and notification system and method utilizing guided artificial intelligence monitors participants in a meeting area and performs both spatial and temporal analysis to detect participant distraction and provide notification of distraction to an administrator. In at least one embodiment, spatial analysis involves observing and analyzing particular features of a participant, such as facial features, body position, body location in an area, activities of the participant, interaction with other participants, and so on. In at least one embodiment, temporal analysis involves changes in the particular features of the participant and the participant's environment over time. The system and method identify anomalies in the detected and extracted participant features in each video frame and across multiple sampled video frames that may indicate that a participant associated with the anomalies is distracted from engaging in a particular task.

### CROSS-REFERENCE TO RELATED APPLICATION

This application claims the benefit under 35 U.S.C. § 119(e) and 37 C.F.R. § 1.78 of U.S. Provisional Application No. 63/632,979, filed Apr. 11, 2024, which is incorporated by reference in its entirety.

### BACKGROUND

### Technical Field:

A system and method relate generally to automated real-time meeting video monitoring and, more specifically, to a computer implemented system and method for automated real-time meeting video monitoring and notification with spatial and temporal analysis to detect participant engagement and distraction.

### Description of Related Art

People often gather in meeting areas, such as rooms, shelters, or outdoors for a variety of purposes. For example, students may periodically gather in classrooms or other educational settings to learn information from a teacher or engage in specific academic exercises. Workmates may gather in a conference area or other meeting area to share crucial organizational information, collaborate on solving a shared organizational challenge, ask for feedback regarding various needs and issues, etc. Such gatherings of participants in meetings may include a presider or other person to provide information, guide discussion with and among the participants, solicit participant input, etc.

In such gatherings, participant engagement is desired. If participants are not engaged or are otherwise distracted from the purpose of the meeting, then those participants may not fulfill the purpose of the meeting, and distracted participants may not provide, receive, or absorb needed information. As a result, it is advantageous to identify participants that may not have been engaged or distracted during some or all of the meetings.

### SUMMARY

A method, system, and non-transitory, computer usable program product for monitoring video of a meeting area for distracted participants including accessing a stream of video data of a set of participants in a meeting area. The method system and program product further perform or cause operations to be performed that include automatically sampling video frames of a stream of video data and automatically detecting a set of features of each of the set of participants in the sampled video frames. The method, system and program product also perform or cause operations to be performed that include automatically identifying participant distraction related anomalies in the set of features including anomalies in each sampled video frame and anomalies across multiple sampled video frames and automatically weighting each of the identified anomalies based on the counted number of sampled video frames. The method, system and program product also perform or cause operations to be performed that include automatically generating a cumulative distraction score for each participant associated with the anomalies for each of the sampled video frames based on the weighted anomalies, automatically determining whether the distraction score for each participant associated with the anomalies exceeds a threshold indicating that the participant is distracted, and automatically providing a notification of each distracted participant to an administrator device.

### BRIEF DESCRIPTION OF THE DRAWINGS

Embodiments of a system and method for automated real-time meeting area video monitoring and notification with spatial and temporal analysis to detect participant engagement and distraction may be better understood, and its numerous features and advantages are made apparent to those skilled in the art by referencing the accompanying drawings. Using the same reference number throughout the several figures designates a like or similar element.

FIG. 1 depicts an overhead diagram of a meeting area, including a video camera utilized for automated real-time video monitoring of participants for participant distraction detection and notification.

FIG. 2 depicts a high-level flow diagram of automated real-time video monitoring of participants in space and time for participant distraction detection and notification.

FIG. 3 depicts an automated real-time video monitoring and distraction analysis and notification system for monitoring meeting area participants in space and time for participant distraction detection and notification.

FIGS. 4A through 4C depict flow diagrams of automated real-time video monitoring of participants in space and time for participant distraction detection and notification.

FIGS. 5A and 5B depict block diagrams of global and local dataframes utilized for tracking participant features in space and time.

FIGS. 6A and 6B depict illustrations of participant features derived from detected participant features by the video processing system 320.

FIG. 7 depicts a single frame of a video clip providing notification of a distracted participant in a meeting area.

FIG. 8 depicts a block diagram of an illustrative data processing system.

FIG. 9 depicts a block diagram of an illustrative network of data processing systems.

### DETAILED DESCRIPTION

A video monitoring and distraction analysis and notification system and method perform automated real-time meeting area video monitoring and notification with spatial and temporal analysis to detect participant engagement and distraction. Although humans can generally intuitively detect participant engagement and distraction, enabling a machine system to detect such engagement and distraction poses a significant technical problem. The video monitoring and distraction analysis and notification system and method provide a technical solution to detect meeting participant distraction to alert and enable an administrator to assist the participant in reengaging with a particular task, such as listening, performing work, reading, engaging with a computer system or other learning tool, and so on. The type of meeting area can be any area in which meeting participants gather, such as a classroom, conference area, shelter, outdoors, or other gathering place for participants to engage in a meeting. The meeting can be for educational, collaborative, or other purposes. A presider, a teacher, or other meeting administrator manages the meeting. The meeting participants may be students, colleagues, attendants, or others. The video monitoring and distraction analysis and notification system and method may be implemented and utilized as will be explained with reference to the various embodiments below.

In at least one embodiment, the video monitoring and distraction analysis and notification system and method includes an automated, and preferably real-time, video processing system that monitors participants in a meeting area and performs both spatial and temporal analysis to detect participant distraction and provide notification of distraction to an administrator. In at least one embodiment, spatial analysis involves observing and analyzing particular features of a participant, such as facial features, body position, body location in an area, activities of the participant, interaction with other participants, and so on. In at least one embodiment, temporal analysis involves changes in the particular features of the participant and the participant's environment over time. The video monitoring and distraction analysis system includes a video camera that provides a video, live-streamed and/or recorded, of participants in a meeting area for processing by the video processing system 320. In at least one embodiment, the video processing system 320 samples the video and analyzes each sampled frame to detect participant distraction. The video processing system 320 may detect selected features of each participant in each sampled video frame and extract additional features from the detected features of each participant. The video processing system 320 identifies anomalies in the detected and extracted participant features in each video frame and across multiple sampled video frames. The anomalies indicate that a participant associated with the anomalies is distracted from engaging in a particular task. The video processing system 320 may weight these identified anomalies for each participant, then accumulate the anomaly weights to generate a cumulative distraction score for each participant. The video processing system 320 applies a threshold to each participant's distraction score to determine whether that participant is distracted. Upon such a determination, the video monitoring and distraction analysis and notification system may provide notification of the participant's distraction, such as with a video clip, to an appropriate user for remediation. Note, the modal verb “may” means that an action expressed by a base verb is not only possible but can be performed and in some embodiments is performed.

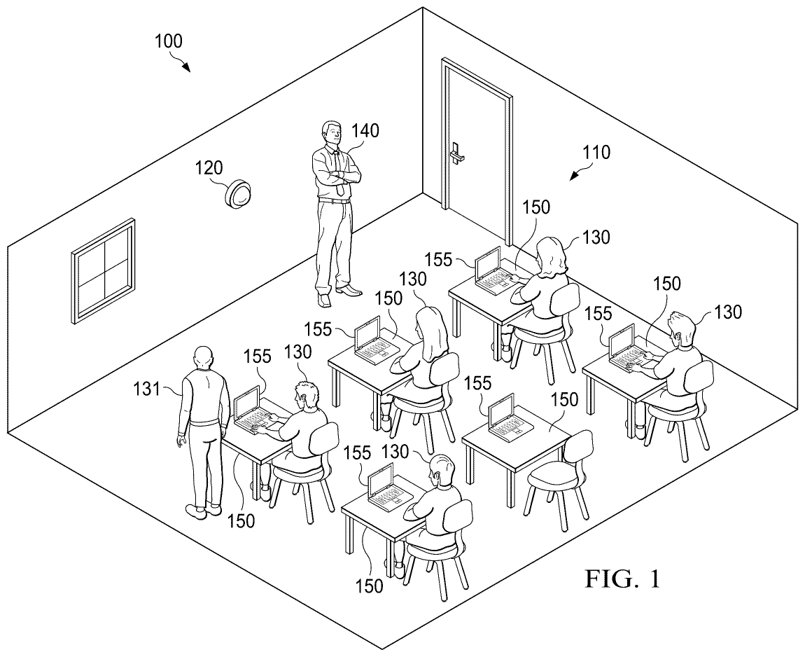

FIG. 1 depicts an overhead diagram 100 of a meeting area 110, including a video camera 120 utilized by a video monitoring and distraction analysis and notification system and method for automated real-time video monitoring of participants 130 in space and time for participant distraction detection and notification, in which various embodiments of the present disclosure may be implemented. Although depicted as rectangular, meeting area 110 could be other polygonal shapes, oval, asymmetrical, or other shapes. Although the participants are depicted seated at desks, such as in a classroom setting, participants may be seated around a conference area table or other setting. The video camera 120 may be located in a position likely to observe the faces of participants 130 when they are engaged with tasks including listening to a presider 140 or another source of information such as a video screen or other electronic device. Although the diagram 100 depicts one video camera, alternative embodiments may utilize multiple video cameras for analysis. In the video monitoring and distraction analysis and notification system and method, video camera 120 is communicatively coupled with video recording and processing equipment as, for example, described below.

Participants 130 may be located at desks 150 in meeting area 110, although a participant 131 may be located away from a desk. Each desk may include a laptop or other electronic device 155 for use by participants 130. Of course, no materials or other materials, such as books, notepads, etc., may be present in the area such as on desks 150. Although the present example depicts six participants and one presider, different numbers of participants and presiders may be included. In addition, instead of configuring the desks of meeting area 110 in rows, the desks and associated participants may be configured in a semi-circle or other configuration. In such a meeting area environment, various embodiments of the present disclosure may be implemented with broad configurability for adaptation to many types of meeting area settings and environments. In addition, many such meeting areas may be monitored, such as in a school, business, or other setting.

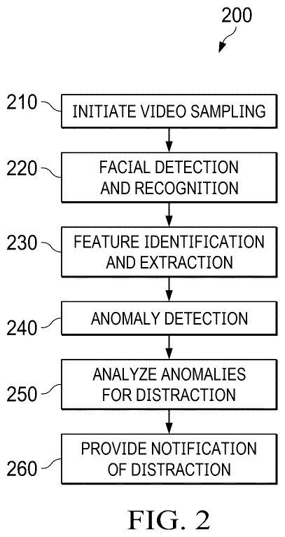

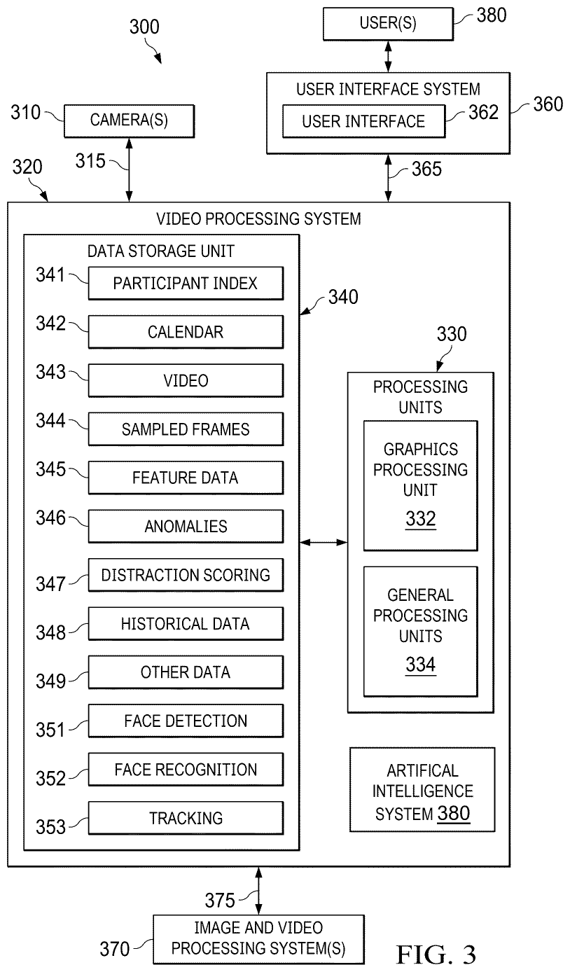

FIG. 2 depicts a video monitoring and distraction analysis and notification process 200 of automated real-time video monitoring of participants in space and time for participant distraction detection and notification, in which various embodiments of the present disclosure may be implemented. FIG. 3 depicts a video monitoring and distraction analysis and notification system 300. In at least one embodiment, the video monitoring and distraction analysis and notification system 300 operates in accordance with the video monitoring and distraction analysis and notification process 200 in the environment of the meeting area 110.

Referring to FIGS. 1, 2, and 3, in a first operation 210, a presider, administrator, or other user initiates a video live stream and/or recording of the meeting area 110 for sampling and analysis. The presider or other administrator 140 may begin the video session as desired, or as previously scheduled utilizing a user interface system 360. Specific administrative processes may precede the video session, such as gathering a set of pictures of participants with identifying information. Once initiated, a video processing system 320 may sample the video for analysis. The sampling rate of the video is a matter of design choice. For example, although a camera 310 may capture the video at a rate of 30 frames per second (fps), the video processing system 320 may sample the video at a rate of 5 fps or every nth frame where n is a positive integer less than or equal to the sampling rate. The video processing system 320 may utilize other sample rates depending on the camera equipment available, the processing power of a system implementing the present embodiment, the ability of a tracker to track individuals over time, and other factors that may be useful depending on the implementation and environment. The video processing system 320 analyzes the sampled video, as described in greater detail below, to identify distracted or otherwise disengaged participants.

In operation 220, the video processing system 320 automatically utilizes facial detection and recognition to identify the participants 130 and their location in the meeting area. More specifically, the video processing system 320 monitors participants over time across multiple video frames to identify a participant who has apparently become distracted, for training to improve anomaly detection of a given participant over time, or for other purposes such as described herein. The video processing system 320 may perform facial detection and recognition for every sampled frame. The video processing system 320 may utilize facial detection and recognition on the first frame of the initiated video and utilize a facial tracking tool that then tracks a facially recognized participant across multiple video frames. The video processing system 320 may also utilize facial detection and recognition when the tracking tool has lost track of a given participant, periodically to verify the tracking tool's identification of participants, as needed when a participant has been identified as being distracted, or at other times.

In operation 230, video processing system 320 may automatically perform feature identification and feature extraction on identified participants 130 in each sampled frame of the meeting area video session. The feature identification and extraction may start with identifying a bounded set of pixels, also referred to herein as a bounded box regardless of the shape of the bounded set of pixels, for each face in feature identification. That is, the video processing system 320 identifies a bounded set of pixels that at least include a participant's face. This bounded set of pixels may be in the shape of a box, an oval, or other shape, including asymmetrical shapes. This bounded set of pixels may also include other visible portions of the participant, such as the shoulders or whole body, for possible analysis, such as posture identification. The video processing system 320 may have previously generated this bounded set of pixels for feature identification of each participant in operation 220, such as when the video processing system 320 performed facial detection and recognition on a given sampled frame.

Once video processing system 320 has identified a bounded set of pixels for a given participant, the system may analyze this set of pixels for identifying and extracting certain features of that participant, indicating that participant's apparent emotions and behavior. For example, the video processing system 320 may identify whether the participant's eyes are open, where the participant's eyes are gazing, where the participant's face is directed, positions of the eyebrows, whether the mouth is open (i.e., such as when a participant is speaking), and other discernable facial and bodily features. The video processing system 320 may further analyze these identified features to extract a predicted emotion of the participant. The predicted emotion may include a level of confidence in that prediction. The video processing system 320 may perform feature identification and extraction for each identified participant in each sampled video frame. The video processing system 320 may automatically store these identified and extracted features, of each participant for each sampled frame for a given meeting area video, in a database for use in detecting anomalies. Such a database may be tabular, including parallel features for each participant across space and time (i.e., spatially and temporally). The video processing system 320 may have previously generated feature identification and extraction elements for each face in operation 220 or whenever the video processing system 320 performed facial detection and recognition on a given sampled frame.

In operation 240, video processing system 320 may automatically compare identified and extracted participant features spatially and temporally to detect anomalies that indicate participant distraction. The video processing system 320 may utilize a set of previously developed rules for detecting such anomalies spatially and temporally. In an alternative embodiment, the video processing system 320 may utilize a machine learning system or other artificial intelligence (AI) system 380 to analyze the database of identified and extraction features for identifying anomalies that may indicate participant distraction. For example, multiple participants may be gazing at the presider on the side of the meeting area while one participant is gazing at the front of the meeting area. While gazing to the front of the meeting area may be the normality, only one participant gazing in that direction in a sampled frame may be considered a spatial anomaly (i.e., in space). For another example, one participant may be looking forward with their mouth open as in speaking in a first set of video frames, followed by another participant looking forward with their mouth open as in speaking in a subsequent set of video frames. As a result, this may not be considered a temporal anomaly (i.e., in time) as the participants may be answering questions from the presider. However, if the participants open their mouths at different times but face each other, they may be conversing with each other such that their actions are considered an anomaly in time, indicating their distraction.

The AI system 380 integration with programmatic operational components of the video processing system 320 provides a technical solution to a technical problem of analyzing video and images to detect distraction of a student. The video processing system 320 include unique guidance and utilization of artificial intelligence (AI) technology to operate AI system 320 by providing, for example, technical, engineered prompts, to analyze video and images to detect student distraction and enable reengagement of a distracted student to facilitate students mastering more material.

The video processing system 320 and video monitoring processes 400, 430, and 470 address technical issues with generating the desired outputs described herein. Conventionally, human observation was used to watch students. However, humans process information much differently than machines. Additionally, even humans who are watching other humans can be distracted themselves, particularly if the human is also teaching. Furthermore, the number of humans an observer can observe and track simultaneously has limits far below the capabilities of video processing system 320 and video monitoring processes 400, 430, and 470. Thus, the video processing system 320 and video monitoring processes 400, 430, and 470utilize an automated system that does not merely automate a manual process or use a conventional system in a conventional way. The video processing system 320 and video monitoring processes 400, 430, and 470 utilize AI system 380 and integrate programmatic process management to technologically guide and constrain the AI system 380 to produce the desired outputs in a completely different way than both any manual process and different than normal use of programs and AI engines. In at least one embodiment, the AI system 380 detects anomalies in video frames in accordance with a technically engineered and generated prompt. The anomalies indicate a distracted participant, and the prompt includes specific guidance to that directs the AI system 380 to detect and identify features of specific anomalies. Exemplary embodiments of AI system 380 utilizes a large language model (LLM) and/or a specialized small language models (SLM). Utilizing specially engineered guidance and control to direct the AI system 320 to solve the “participant distraction detection” problem below presents a technical problem that requires a technical solution. The video processing system 320 and video monitoring processes 400, 430, and 470 are not simply engaging a computer to carry out conventional mental processes but rather change how computers AI system 380 operate to achieve results that were not previously possible or were substantially inefficient prior to the video processing system 320 and video monitoring processes 400, 430, and 470. The AI system 380 needs specific technical guidance, control, and constraints to achieve results that are not otherwise achievable.

Without proper guidance and constraints, AI system 380 will not produce the desired output specified as produced by the system and method described herein. Instead, the AI system 380 will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The technically engineered prompts are generated and guided with programmatic, automatic inputs specifically designed to unconventionally guide and constrain AI system 380 to produce desired outputs and make the desired outputs available for use, such as use by computer system applications. In at least one embodiment, the problem to be solved by the video processing system 320 and video monitoring processes 400, 430, and 470 is uniquely and unconventionally decomposed, and AI prompts are used to solve the decomposed problem. Furthermore, the programmatic inputs to the decomposed AI prompts provide guidance to meet desired output characteristics.

The video processing system 320 and video monitoring processes 400, 430, and 470 improve conventional methods through the use of video processing system 320 and video monitoring processes 400, 430, and 470 to include selected and integral AI engine guidance and constraints. Thus, incorporation of the guided AI system 380 provides useful results that improve existing technical processes, which is not an automation of a conventional process.

Programmatic components of video processing system 320 including AI system 380 generally utilize one or more processors that have access to memory, which may include one or more storage components, to execute and perform functions. The AI system 380 is a core hardware and software system that enables artificial intelligence applications to process data, learn patterns, and generate insights or actions. The AI system 380 functions as the brain behind AI-driven systems, facilitating tasks such as machine learning, natural language processing, and decision-making. Exemplary components of AI system 380 are:
Machine Learning Models—Algorithms that analyze data, recognize patterns, and make predictions.
Neural Networks—Deep learning architectures that mimic the human brain for tasks like image and speech recognition.
Data Processing Module—Handles raw data input, transformation, and feature extraction.
Inference Engine—Applies trained models to make real-time decisions based on new data.
Optimization Algorithms—Improves model efficiency, reducing errors and improving predictions.
Natural Language Processing (NLP) Module—Enables AI engines to understand, interpret, and generate human language (e.g., chatbots, voice assistants).
Computer Vision Module—Allows AI to interpret and analyze images or videos.
Reinforcement Learning Mechanism—Helps AI learn from trial and error, optimizing performance over time.
API Interface—Connects the AI engine with applications, enabling integration with other software or platforms.
Examples of AI Engines include: Google TensorFlow, Meta's PyTorch, Microsoft Azure AI, OpenAI's GPT, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

The following prompt is an exemplary prompt used to guide AI system 380 to detect a distracted participant:

Below is a prompt designed to guide AI system 320 to analyze video frames of a student and detect distraction based on the specified criteria—facial features (eyes, gazing, mouth movement), body position, body direction, body motion, and location within a room relative to a desk. The prompt is structured to ensure clarity, specificity, and comprehensive coverage of the required analysis while maintaining flexibility for the AI system to adapt its processing.
###Prompt for AI System
Input 1: [programmatic insertion of threshold e.g. 1, 2, 3, 4, or 5 secs]
Input 2: [programmatic insertion of dataframes of sampled video]
“You are an AI system tasked with analyzing video frames to detect whether a human subject, specifically a student, is distracted while supposed to be engaged in on-task learning activities, such as using a computer or listening to a lecturer. Your objective is to evaluate the student's level of distraction by processing a real-time or recorded stream of video data and examining multiple indicators of behavior. To determine distraction, systematically analyze the following five categories of features in each video frame and across sequences of frames, using a combination of computer vision techniques, pattern recognition, and temporal analysis:
1. Facial Features:
   Eyes: Detect eye openness (e.g., fully open, partially closed, or blinking excessively) and track eye movement to assess focus. Identify if the eyes are directed toward the computer screen, lecturer, or expected learning material, or if they are wandering elsewhere (e.g., off-screen or toward unrelated objects).
   Gazing: Analyze gaze direction using eye-tracking algorithms to determine if the student is fixated on the task (e.g., screen or lecturer) or looking away for prolonged periods (e.g., more than [Input 1]). Flag inconsistent or erratic gaze patterns as potential distraction indicators.
   Mouth Movement: Monitor mouth activity to distinguish between on-task behavior (e.g., silent focus or speaking relevant to the task) and off-task behavior (e.g., yawning, chewing, or talking unrelated to learning). Use lip motion detection to identify extended periods of non-learning-related activity.
2. Body Position:
   Assess the student's posture to determine engagement. Identify if the student is sitting upright or leaning toward the desk (suggesting focus) versus slouching, leaning back, or resting their head on their hand (suggesting disengagement or fatigue). Use skeletal mapping or keypoint detection to classify posture states.
3. Body Direction:
   Evaluate the orientation of the student's torso and head relative to the learning environment. Confirm if the body is facing the computer screen or lecturer (indicating attention) or turned away toward unrelated areas (e.g., sideways, backward, or toward a wall). Use angle estimation to quantify deviations from the expected forward-facing direction.
4. Body Motion:
   Track movement of the student's body, including arms, head, and torso, over time. Detect excessive or repetitive motions (e.g., fidgeting, rocking, or turning around) that deviate from minimal, task-focused movements (e.g., typing or note-taking). Use motion vectors or frame-to-frame differencing to quantify activity levels and flag high-motion sequences as potential distraction.
5. Location of Body Within Room and Relative to Desk:
   Determine the student's spatial position in the room relative to a desk or workstation. Verify if the student is seated at the desk (consistent with task engagement) or displaced (e.g., standing, walking away, or sitting elsewhere). Use depth estimation or object detection to measure the distance between the student's body and the desk, flagging significant deviations (e.g., more than 1 meter away) as indicators of distraction.
Processing Guidelines:
   Frame Analysis: For each video frame, extract and evaluate the above features using pre-trained machine learning models (e.g., convolutional neural networks for facial feature detection, pose estimation models for body analysis). Assign a confidence score to each detected feature state (e.g., eyes on-screen: 0.9, body turned away: 0.8).
   Temporal Analysis: Analyze sequences of frames (e.g., over 10-second windows) to identify patterns or anomalies, such as prolonged gaze aversion, sustained off-task posture, or repeated motion. Compute a cumulative distraction metric by weighting features based on their duration and severity (e.g., gazing away for 20 seconds is more significant than 5 seconds).
   Contextual Integration: Combine findings across all five categories to form a holistic distraction assessment. For example, if the student's eyes are off-screen, body is turned away, and they are fidgeting simultaneously, this strengthens the distraction conclusion compared to a single indicator.
   Thresholding: Establish a distraction threshold (e.g., a score above 0.7 on a 0-1 scale) based on calibrated norms for on-task behavior. Flag the student as distracted if the cumulative metric exceeds this threshold.
   Output: Generate a report for each analysis window, including a binary distraction determination (distracted/not distracted), a distraction score, and a breakdown of contributing factors (e.g., ‘gaze away: 40%, excessive motion: 30%’). Optionally, provide visual annotations on the video frames (e.g., bounding boxes around the face or body) to highlight detected anomalies.
Assumptions and Calibration:
   Assume the student is expected to face a computer screen or lecturer within a defined field of view unless otherwise specified.
   Calibrate the system using labeled training data of on-task and distracted behaviors to refine feature detection and scoring.
   Adjust sensitivity to account for natural variations (e.g., brief glances away or minor posture shifts are not flagged unless persistent).
Proceed with the analysis and return the distraction assessment, ensuring the system remains adaptable to different classroom settings and student behaviors.”
##Explanation of Prompt Design
1. Clarity and Structure: The prompt breaks down the five required categories explicitly, ensuring the AI addresses each one systematically.
2. Technical Guidance: It incorporates specific methods (e.g., machine learning, skeletal mapping, temporal analysis) to make the analysis actionable for an AI system while leaving room for implementation flexibility.
3. Comprehensive Detection: It balances single-frame analysis (e.g., current posture) with temporal patterns (e.g., prolonged gaze aversion), capturing both immediate and sustained distraction.
4. Practical Output: The prompt specifies a clear, usable result (distraction score, report) aligned with real-world applications like classroom monitoring.
5. Adaptability: Assumptions and calibration instructions allow the AI to adjust to varied contexts without overcomplicating the prompt.##

Then, in operation 250, video processing system 320 may further analyze the identified anomalies automatically to determine whether such detected anomalies in space and time indicate a distracted participant. This analysis may include applying weights to detected anomalies, accumulating and smoothing such weights for each participant over time, and then comparing the accumulated and smoothed weights to a predetermined threshold to determine whether any participant may be distracted. Alternative embodiments may utilize other methods to determine whether a participant may be distracted based on detected anomalies.

Video processing system 320 may weight the detected temporal anomalies by automatically applying weights to each detected temporal anomaly for each participant based on the number of sampled frames processed prior to the detected anomaly. That is, the greater the number of frames analyzed prior to or in the process of detecting a temporal anomaly, the greater the confidence in the determination of participant distraction detection. For example, if the video processing system 320 processes a significant number of sampled frames before identifying a particular temporal anomaly in a given frame, then the detected anomaly may be considered more unusual, indicating greater significance of that anomaly. For another example, a greater number of frames incorporating a given temporal anomaly for a given participant may also indicate the greater significance of that anomaly. Other types of anomaly weighting may be utilized for spatial or temporal anomolies, such as based on prior experience. That is, certain types of detected anomalies may have previously been determined to be strong indicators of participant distraction. Such weighting may have been previously identified and utilized based on anecdotal information, statistical analysis, trained artificial intelligence, and/or other machine learning. Such weighting may be implemented through a set of rules based on such analysis.

Video processing system 320 may automatically aggregate and accumulate the weighted spatial and temporal anomalies, then smooth the weighted anomalies over time for each participant to generate a distraction score. In an alternative embodiment, the spatial and temporal anomalies may not be aggregated, resulting in multiple distraction scores for each participant. Such multiple distraction scores may be processed in parallel through the following process operations. The smoothing process may reduce the frequency of outliers, thereby helping reduce false positives. This aggregating, accumulating and smoothing of detected anomalies may be limited to certain periods of time (e.g., every 10 seconds) or limited to a period of time whereby a given participant is exhibiting detected anomalies (e.g., until the participant does not exhibit detected anomalies for a predetermined number of sampled frames). If the detected anomaly is limited to one sampled frame, such aggregation, accumulation and smoothing may be limited in scope. The video processing system 320 may then compare this distraction score to a predetermined threshold. This predetermined threshold may be equivalent for each participant, vary by participant, vary by the length of time that the detected anomalous features continued, etc. This distraction score may also be normalized and then rounded or otherwise reduced to a binary score of 0 (i.e., false indicating no distraction) or 1 (i.e., positive indicating the participant is distracted). Alternatively, the video processing system 320 may normalize the distraction score and then express it as a percentage. The distraction score may also be expressed inversely as an engagement score. The video processing system 320 may utilize other types of statistical analysis, artificial intelligence, machine learning or other tools on the weighted anomalies to identify whether a given participant may be distracted, whether in space for a given frame or in time across multiple frames.

In operation 260, video processing system 320 may automatically generate a notification of the positive distraction scores. This notification may be automatically provided to a presider, administrator, teacher, parent, or other appropriate user. The video processing system 320 may automatically provide a screenshot, a video clip, or other visual imagery with the notification to indicate the distracted participant at the time of distraction. Such visual imagery may include an image of the distracted participant during distraction. The visual imagery may include part or all of the frame or set of frames in order to provide a visual context of the distracted participant. Additional frames prior to or subsequent to the period of distraction may also be included to provide context. The video processing system 320 may highlight the distracted participant in the visual imagery, such as with a bounded set of pixels provided in operation 230 above. The video processing system 320 may also provide a distraction score for that participant during the visual imagery. This distraction score may be embedded in the visual imagery, expressed as a colored highlight, or other form of indication. The video processing system 320 may provide the distraction score as a binary or a non-binary score. If multiple participants are distracted, then the video processing system 320 may or may not highlight all such distracted participants with a distraction score, depending on the user observing the visual imagery (e.g., teacher versus parent of a student). If provided as a video clip, the video processing system 320 may include some or all intervening frames not sampled in the visual imagery to give a less stilted video. The video processing system 320 may also provide the bounded set of pixels and distraction score in the intervening frames through the use of interpolation or other techniques.

Video processing system 320 may store the generated notification and visual imagery in memory and/or provide the notification and visual imagery to the presider or other user in real-time or later. That is, the presider or other user may receive an aural or other indication of a distracted participant along with just generated visual imagery of the distracted participant. The video processing system 320 may provide this information to the presider or other user upon request or in a daily or periodic report. The video processing system 320 may provide many different forms of notification depending on the applicable circumstances and environment. For example, a requested report for an administrator may include all distracted participants, but a requested report for a parent of a student may only include information regarding that student.

FIG. 3 depicts an automated real-time video monitoring and distraction analysis and notification system 300 for monitoring meeting area participants in space and time for participant distraction detection and notification, in which various embodiments of the present disclosure may be implemented. The description of FIG. 3 includes references to elements of FIGS. 1 and 2. Video monitoring and distraction analysis and notification system 300 may include one or more cameras 310, a video processing system 320, a user interface system 360, and additional image and video processing system(s) 370. Camera 310 may be electronically coupled with the video processing system 320 through connection 315. User interface system 360 may be electronically coupled with the video processing system 320 through connection 365. Image and video processing system(s) 370 may be electrically coupled with video processing system 320 through connection 375. Connections 315, 365, and 375 may be a wired and/or wireless connections, including the use of a router or other network device as needed. As may be appreciated by one skilled in the art, connections 315, 365, and 375 may share the same or different electronic interfaces depending on the implementation circumstances and needs.

Referring to FIGS. 1, 2 and 3, camera 310 may be located in a meeting area, such as meeting area 110, for monitoring participants in that meeting area. Video processing system 320 may instruct or otherwise invoke camera 310 to provide a video signal across connection 315 to video processing system 320 at select periods of time, also referred to herein as a video monitoring session. A user may utilize user interface system 360, in connection with video processing system 320, to initiate the video monitoring session. Video processing system 320 may monitor multiple meeting areas, perhaps concurrently, each meeting area having one or more cameras connected with video processing system 320 for monitoring participants in each meeting area.

User interface system 360 may include a user interface 362 for communicating with user(s) 380, such as a meeting presider, administrator, or other user. A user 380 may utilize user interface system 360 to select a time for camera 310 to start monitoring participants in a given meeting area. User 380 may also utilize user interface system 360 to generate a participant index database, as described below. Furthermore, video processing system 320 may also utilize user interface system 360 to provide notifications of distracted participants or other notifications to user(s) 380. Different users may utilize multiple user interface systems 360. For example, there may be a separate user interface system for each meeting area, for each presider, for a system administrator for managing a participant index database, and/or other users as desired. In addition, multiple users may utilize the same user interface system through the use of login protocols and other security measures. Although user interface system 360 is depicted communicating with video processing system 320, such as for turning on video camera 310, user interface system 360 may also communicate directly with camera 310.

Video processing system 320 may also utilize image and video processing system(s) 370 to handle some image and video processing workload on behalf of video processing system 320. For example, video processing system 320 may receive and sample video of participants from camera 310, but then utilize one or more image and video processing system(s) 370 to process certain elements of each sampled frame. Image and video processing system(s) 370 may be closely coupled and within a common firewall with video processing system 320. Image and video processing system(s) 370 may also be located outside a firewall from video processing system 320. Image and video processing system 320s may also be located in a cloud or other remote environments. Many other such image and video processing system 320 configurations may be utilized as desired and needed for a given implementation and environment.

Video processing system 320 may include processing units 330 and data storage unit 340. Processing units 330 include one or more processors of general processing units 334 for handling non-graphical data as well as graphical processing units 332 for processing graphical data such as video and video frames. As may be appreciated by one skilled in the art, many types of processing units and configurations thereof may be utilized, when operating as specialized machines according to embodiments of the video monitoring and distraction analysis and notification system 300 described herein, to process video data as well as manage communications with users through user interface system 360. Data storage unit 340 may store various types of captured and processed data, including a participant index database 341, calendar 342, video data 343, sampled frames 344, participant feature data 345, participant detected anomalies 346, participant engagement scoring 347, historical data 348, and other data 349 (e.g., system configuration data) such as described herein. Data storage unit 340 may also store software, including face detection software 351, face recognition software 352, tracking software 353, and other software 354 such as described herein. Data and software may also be stored and accessed remotely, in the cloud, or in other locations as desired.

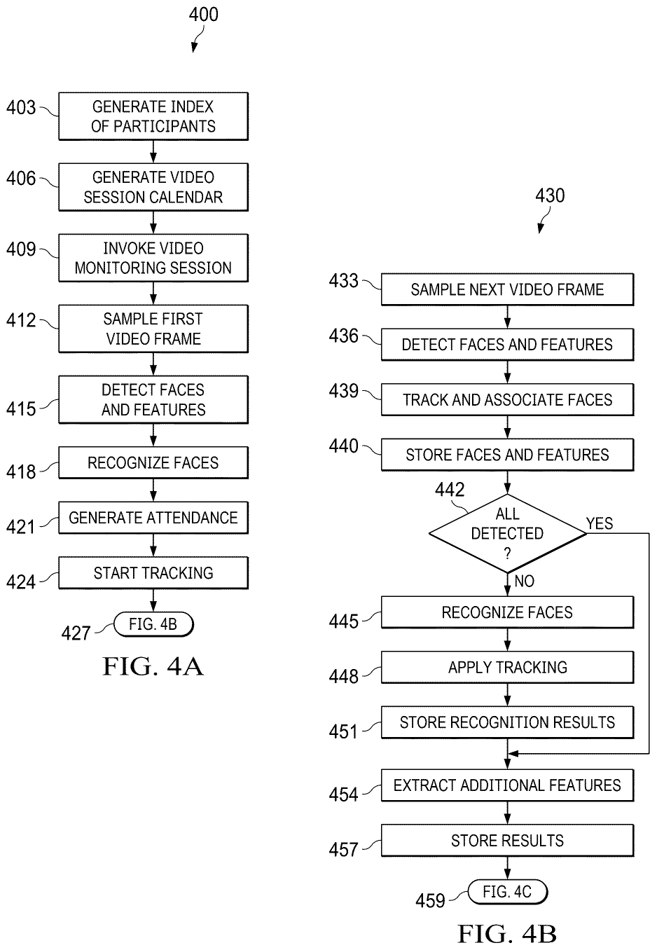

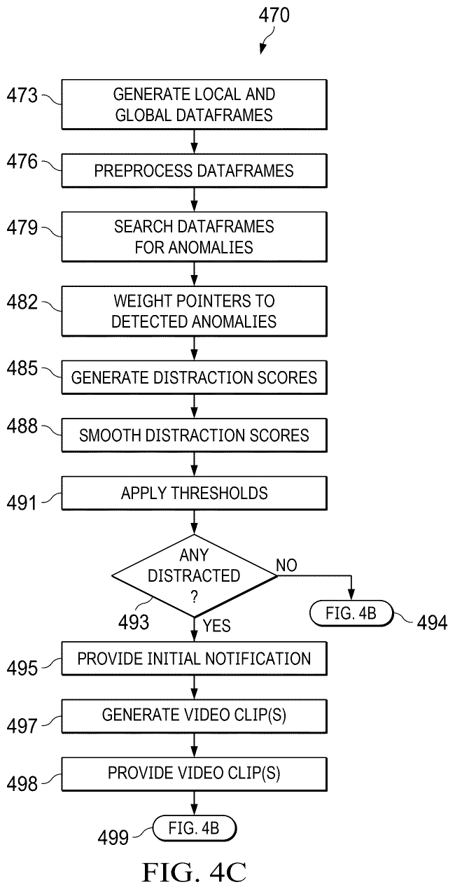

FIGS. 4A, 4B, and 4C depict respective automated, real-time video monitoring processes 400, 430, and 470 that are performed by the video monitoring and distraction analysis and notification system 300. The video monitoring processes 400, 430, and 470 allow the video monitoring and distraction analysis and notification system 300 to monitor participants in space and time for participant distraction detection and notification, in which various embodiments of the present disclosure may be implemented. The following embodiment describes utilizing a single camera in a single meeting area. However, alternative embodiments may utilize multiple cameras for a given area or multiple areas with one or more cameras each.

The processes depicted in FIGS. 4A through 4C are described below as a real-time automated process whereby the distraction of participants may be detected on a sampled video frame by sampled video frame basis. That is, the processes described below are directed to focusing on the currently processed video frame and prior processed video frames automatically and in real-time. An automated process includes operations that occur without human intervention, such as described in the below process operations except during some of the operations described in FIG. 4A whereby a human may assist in generating a participant index database and a calendar as well as initiating the monitoring video session in some cases. Automated and real-time processing occurs quite rapidly with internal processing latency delays, such as in a few seconds, and is considered “real-time.” Alternatively, the processes described below could be implemented in a significantly delayed manner, such as after the meeting has been completed. In delayed processing, some of the below processes could be modified accordingly. For example, the smoothing of data may include mostly backward-looking data in real-time processing and may include significant forward-looking data in delayed processing.

Referring to FIGS. 1, 2, 3, 4A, 4B, and 4C, FIG. 4A depicts a flow diagram 400 performed by the video monitoring and distraction analysis and notification system 300 initiating a video monitoring session for automatically determining whether the participants may be distracted, in which various embodiments of the present disclosure may be implemented. This video monitoring session may include video monitoring and distraction analysis and notification system 300 generating an index of participants, setting up a calendar of video monitoring sessions, and starting a video monitoring session, including taking attendance. FIG. 4A may depict, in greater detail, operation 210 along with elements of operations 220 and 230 of FIG. 2 described above.

In a first operation 403, a user interface (UI) system 360 user, such as an administrator, presider, or other user, assists in generating a database with an index of participants 341 through user interface 362. The UI system 360 user assists in generating a participant index database before the first monitoring video session by utilizing camera 310 or another camera to take solo pictures associated with each participant by providing identifying information such as the name and identification number of the associated participant through user interface 362 and providing any grouping information such as group identifiers associated with selected participants through the user interface. The solo pictures may be from multiple angles to better enable facial recognition. The participant index database may also be generated at the beginning of the first monitoring video session. Utilizing the meeting area camera, each participant could sit or stand still for a first frame while a presider or other user utilizes user interface 362 to assign a name or other identifying information for each participant. The presider or other user may repeat this process from different angles (e.g., each participant rotates their head left and right) to provide a better participant index database for improved facial recognition. Alternatively, video processing system 320 may automatically generate a participant index database from the first frame(s) of the first video monitoring session for each uniquely detected face, followed by an administrator or other user assigning identifying and additional relevant information regarding each participant later. As may be appreciated by one skilled in the art, other alternative embodiments may be utilized to generate the participant index database.

In a second operation 406, the UI system 360 user may generate or otherwise implement a video monitoring session calendar 342 to identify when a video monitoring session should be invoked (i.e., started and stopped). This calendar establish exact times or ranges of times that the video monitoring sessions may be started and stopped by a meeting presider or other user. The video monitoring session calendar may be implemented for multiple meeting areas, or separate calendars may be set up for each meeting area. The calendar may also include an identified set of expected attendees for each calendared video monitoring session through the use of group identifiers associated with selected participants during the registration operation described above.

In operation 409, video processing system 320 invokes or otherwise initiates a video monitoring session for a given meeting area. This video monitoring session may be initiated by video monitoring session calendar 342, by a user on an ad hoc basis through user interface system 360, or by another system or user. As part of the monitoring session initiation, video processing system 320 may identify a set of expected participants for the video monitoring session by accessing a group identifier or list of participants from calendar 342 or by receiving a group identifier or list of participants from a user such as a presider through user interface system 360. As a result of the initiation of the video monitoring session, meeting area camera 310 may transmit video for processing by video processing system 320 360. Camera 310 may have previously transmitted video to the video processing system 320 to establish communications across connection 315. Once the video monitoring session has been initiated, video processing system 320 may store the ongoing stream of video to video data 343 and begin processing that video data for monitoring the participants.

Then, in operation 412, video processing software 354 of video processing system 320 samples a first video frame from the video. Depending on the video data stream, video processing system 320 may simply grab a sequential frame from the video stream, or it may require decompression and decryption of the video data, particularly if the video data stream includes multiple frame compression and/or encryption. Then, in operation 415, video processing system 320 invokes and utilizes face detection software 351 to identify any faces in the video frame (also referred to herein as a video image), associate a bounded set of pixels for each identified face, and identify any preselected facial and postural features from the identified face and connected body in the bounded set of pixels. The preselected facial and postural features are described in greater detail below. Given that this is the first frame of the video monitoring session, in operation 418, video processing system 320 may invoke and utilize facial recognition software 352 to identify each detected face with a participant from participant index database 341 to generate a set of identified participants. Then in operation 421, video processing system 320 may compare the set of identified participants with the set of expected attendees through the use of associated group identifiers to generate an attendance of participants. If the facial recognition software does not recognize a detected participant, then a photo of that participant may be flagged or otherwise indicated as a non-recognized participant. Such a non-recognized participant may be a presider or other user who is a guest in the meeting area. Depending on predetermined selections or upon input from the presider through user interface system 360, the non-recognized participant may be ignored through the rest of the monitoring session, or the non-recognized participant may be treated as a known participant through the rest of the monitoring session. The video processing system 320 may store the determined attendance of the monitoring session in memory 340. In operation 424, video processing system 320 may provide the bounded set of pixels for each detected face, as well as locations of trackable features for each participant's face (e.g., each eye's center location) to tracking software 353 for use in tracking each participant through subsequent sampled frames as described herein. Utilizing tracking software may reduce the need to utilize face detection software for each sampled frame. The video monitoring session of the participants in the meeting areas may then continue 427 to the operations described with reference to FIG. 4B below.

In an alternative embodiment with multiple cameras in the meeting area, the video processing system 320 may utilize the processes described herein for each camera. The video processing system 320 may utilize the camera with the best view (i.e., best detected features) for each participant for monitoring that participant. In a further alternative embodiment, each camera may monitor each detected participant in parallel with the other video cameras, with the results of the monitoring of each camera averaged or otherwise combined for each participant.

FIG. 4B depicts a flow diagram 430 of automatically identifying and extracting participant features in a video monitoring session, in which various embodiments of the present disclosure may be implemented. This process may include video monitoring and distraction analysis and notification system 300 detecting faces and features, identifying participants from the detected faces and features, and extracting additional facial and bodily features from the detected faces and features. FIG. 4B may depict, in greater detail, operations 220 through 230 of FIG. 2 described above.

In operation 433, video processing system 320 may sample a subsequent video frame from the video stream. As described above, the video processing system 320 may sample every nth video frame. Depending on the video data stream, the video process system may simply grab a sequential frame from the video stream, or may need to use decryption and decompression, particularly if the video stream includes multiple frame compression and/or encryption. The video processing system 320 may store the sampled video frame in memory in sampled frame 344. Then, in operation 436, video processing system 320 may utilize face detection software 351 to detect any faces in the current sampled video frame (also referred to herein as a video image), associate a bounded set of pixels for each detected face, and identify any preselected facial and postural features from the identified face and connected body in the bounded set of pixels. In the present embodiment, video processing system 320 may utilize face detection software such as Amazon Rekognition software's detect_faces to detect faces and identify certain preselected facial and postural features. These preselected facial and postural features may include eye size and shape features, eye gaze direction, nose position, mouth occlusion, head position, eyebrow curvature, eye openness, mouth openness, smile, confusion, apparent emotion, and other features. In operation 439, video processing system 320 may utilize tracking software 353 to identify and associate each detected face with a previously identified participant by comparing the locations of the bounded set of pixels and the trackable features of each identified participant from the prior sampled video frame. Then, in operation 440, video processing system 320 may store the preselected facial and postural features for each identified participant in participant feature database 345.

In operations 433 through 439, the video processing system 320 may process each sampled video frame by participant or frame. Depending on the software's capabilities and the computational environment, the video processing system 320 may make calls to the face detection software, face recognition software, and/or tracking software for each sampled video frame. Alternatively, the video processing system 320 may make calls to the face detection, face recognition, and/or tracking software for each participant in each sampled video frame, sending only a bounding box of data for each participant.

In operation 442, video processing system 320 determines whether all attending participants are detected and identified in the current sampled video frame. The video processing system 320 might not detect and identify a participant if that participant moved quickly (e.g., such as by standing up or walking, making the change in the participant's position untrackable by tracking software 353), if that participant turned their head such that face detection software 351 is unable to detect their face, etc. If yes, in operation 442 (i.e., all attending participants are detected and identified), then processing continues to operation 454; otherwise, processing continues to operation 445. In operation 445, the video processing system 320 may utilize facial recognition software on the current video frame to identify the missing participants. In the present embodiment, video processing system 320 may utilize face recognition software such as Amazon Rekognition software's recognize_faces to detect faces and identify certain participant features. Then in operation 448, the video processing system 320 may provide the bounded set of pixels for each newly recognized participant and locations of trackable features for each face (e.g., each eye's center location) to tracking software 353 for use in tracking each participant through subsequent sampled frames as described herein. In the present embodiment, the video processing system 320 may utilize tracking software such as OpenCV CSRT tracker to track participants from frame to frame. In operation 451, if a participant previously identified as attending in the first video frame is not recognized in operation 445, then the video processing system 320 indicates that the participant is missing for this sampled video frame in participant feature database 345. If the video processing system 320 software recognizes a participant previously identified as attending in the first video frame in operation 445, then the video processing system 320 stores the preselected facial and postural features for that recognized participant in participant feature database 345. Processing may then continue to operation 454.

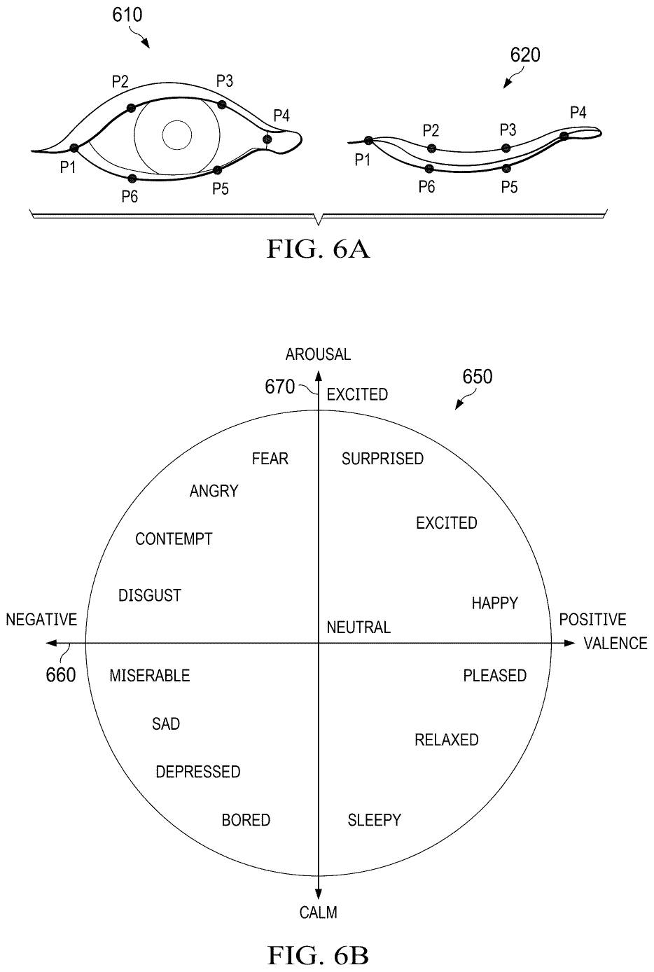

In operation 454, the video processing system 320 processes the bounded set of pixels and the identified features for each identified participant for extracting additional preselected features of the participant. For example, the video processing system 320 may perform computations on each participant's identified facial and postural features to extract additional participant features. These extracted participant features may include an eye aspect ratio (EAR), valence and arousal factors of the participant's apparent emotion, a direction where the participant's face points, etc. These extracted participant features may also include multi-frame features such as changes in the direction where the participant's eyes are gazing. Examples of extracted participant features are described in greater detail below with reference to FIGS. 6A and 6B. The video processing system 320 may also analyze participant body features to extract certain postures indicating alertness or otherwise. Then in operation 457, the video processing system 320 may store these extracted facial and body features in feature data 345 for each participant for the current sampled video frame. The video monitoring session of the participants in the meeting areas may then continue 459 to the operations described with reference to FIG. 4C below.

In an alternative embodiment with multiple cameras in the meeting area, the above operations 433 through 457 may be utilized for each camera. When a participant may be missing from the sampled video frame of a first camera in operation 439 or operation 445, video processing system 320 may utilize facial recognition for that missing participant on the other camera's sampled video frame. If successful, the video processing system 320 may utilize the other camera to monitor that participant as long as that participant is trackable. In a further alternative embodiment, the video processing system 320 may perform facial recognition on selected sampled video frames to verify that tracking software 353 is performing successfully.

FIG. 4C depicts a flow diagram 470 of automatically detecting participant distraction, in which various embodiments of the present disclosure may be implemented. This process may include video monitoring and distraction analysis and notification system 300 detecting and weighting anomalies from the participant's detected and extracted features in space and time, engagement scoring and thresholding based on the detected and weighted anomalies, and notification of detected distraction. FIG. 4C depicts, in greater detail, operations 240 through 260 of FIG. 2 described above.

In operation 473, video processing system 320 may generate global and local dataframes including participant features in space and time. That is, the video processing system 320 may generate a global dataframe in space from the current sampled video frame, including a row for each participant, and columns for a global set of identified and extracted features. The set of global features may include features that have historically demonstrated to be statistically significant in determining a participant's engagement and/or distraction for a given video frame. For example, the size of a participant's eyes may not be statistically significant by itself, whereas the direction of a participant's gaze may be statistically significant in determining whether the participant may be currently engaged or distracted. The set of global features may also include features useful in determining statistically significant extracted features. In addition to a set of global dataframes, the video processing system 320 may generate a set of local dataframes in time, one local dataframe for each participant. Each local dataframe for a given participant may include a row for each sampled video frame, including the current sampled video frame, and columns for a local set of identified and extracted features for that participant. The set of local features may include features that have historically demonstrated to be statistically significant in determining the engagement and/or distraction of participants across multiple video frames. The set of local features may also include features useful in determining statistically significant extracted features.

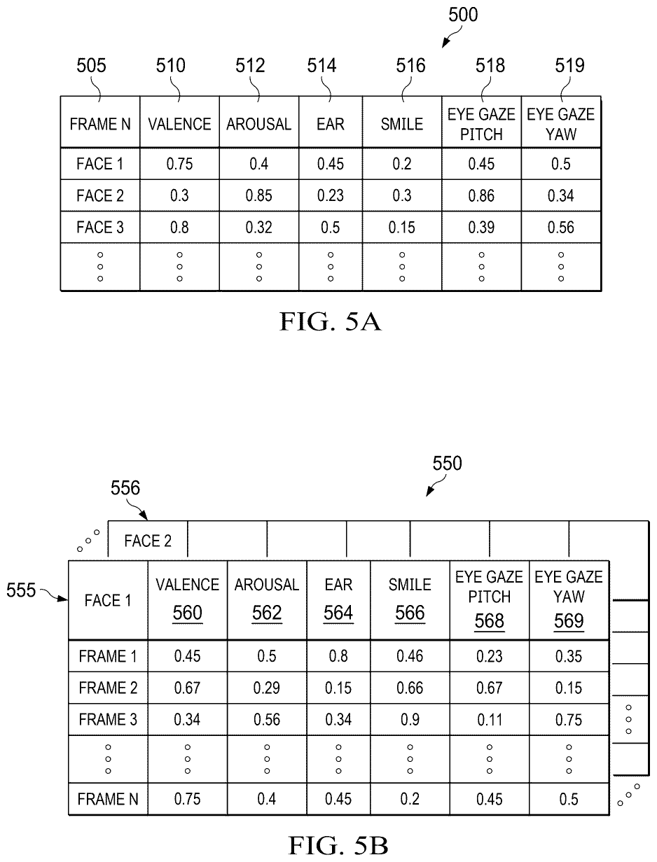

The sets of global and local features may differ or include a superset of participant features statistically significant for determining a participant's engagement or distraction in space or time (i.e., globally or locally). The video processing system 320 may determine the statistical significance of features through programmatic statistical analysis of historical data, anecdotal information, and analysis of video frames by AI system 380. Additional features not known to be statistically significant and/or helpful in determining extracted features may also be detected and extracted for building a historical database of those additional features in historical data 348 so that further analysis of those features for significance can be performed later. The video processing system 320 may store the global and local dataframes in feature data 345. An example of the global and local dataframes is described in greater detail below with reference to FIGS. 5A and 5B.

Then, in operation 476, video processing system 320 may perform preprocessing on the local and global dataframes for anomaly detection. Such preprocessing may be useful in improving anomaly detection and reducing computational workload. This preprocessing may include standardizing the prior feature data for each detected and extracted feature for each participant from the local dataframe. In the present embodiment, the video processing system 320 may standardize this prior feature data with a mean of zero and a unit variance. Video processing system 320 may have performed this preprocessing while preprocessing data from the prior sampled video frame. This may be possible in the present embodiment because the video processing system 320 may only include prior data in such standardization to help prevent any current anomalies from influencing the standardization process of the current video frame. In alternative embodiments, the video processing system 320 may utilize other types of standardization, including techniques that also provide a center and range of data. The selection of standardization utilized may be based on the anomaly detection technique utilized in operation 479 below. The video processing system 320 may utilize the scalars generated during this standardization of prior feature data from the local dataframes to standardize the current feature values for each participant in the current global dataframe. The video processing system 320 may subtract the standardized current feature data of the global dataframe from the standardized prior data to show differences between the standardized current feature values and standardized prior feature values for each feature of each participant. For the local dataframes, the video processing system 320 may utilize the scalars generated during the standardization of prior feature data to standardize the current feature values for each participant in the current frame of the local dataframe for each participant.

In operation 479, video processing system 320 may search preprocessed dataframes to detect global and local anomalies. Such feature data anomalies may indicate that a participant is distracted. In the present embodiment, the video processing system 320 may utilize Isolation Forest detection techniques, such as from scikit-learn. org, to isolate and identify anomalies. Isolation Forest is a computationally quick tree-based technique for detecting data points that do not follow established patterns in data. For global dataframes, identified anomalies may include a pointer to each participant's face, including a set of anomalous global data, whereby each pointer provides an initial weighted value of 1 in the present embodiment. For local dataframes, identified anomalies may include a pointer to each frame and face including anomalous local data, each pointer provided an initial weighted value of 1 in the present embodiment. These pointers to anomalies may be stored in memory in anomalies database 346 for further processing and for retention of data for future analysis. The video processing system 320 may utilize other anomaly detection techniques, such as other statistical techniques, and AI system 380. For example, in at least one embodiment, operation 479 generates a prompt for AI system by, for example, populating values for variables in the AI system 380 prompt earlier described and submitting the prompt and access to the dataframes to the AI system 380 to detect participant distractions. Ths AI system 380 then provides detected anomalies to participant detected anomalies 346 data storage.

The video processing system 320 then weights the pointers to each detected anomaly in operation 482. In the present embodiment, this weight could be a linear multiplier based on the number of prior frames. With more prior frames to establish patterns of participant features, the detected anomalies may be inherently more reliable. In alternative embodiments, the multiplier may be non-linear, an additive scale, or other weighting factors that reflect the reliability of detected anomalies. The video processing system 320 may apply other types of weighting in alternative embodiments. For example, certain types of anomalies (e.g., mouth open while head turned) may be more predictive of a distracted participant, and the pointer weight could be adjusted accordingly.

Then, in operation 485, the video processing system 320 generates a distraction score (or alternatively an engagement score) for each participant in each sampled video frame, whether globally in space or locally in time. For example, a given participant may have anomalously had their mouth open while gazing to the side in the current sampled video frame, and may have anomalously moved about the meeting area the past few sampled video frames, resulting in a global anomaly in the current video frame while also resulting in a local anomaly in time which is still detectable in the current video frame. Each such anomaly for this participant may have a higher weighted pointer to those anomalies, as provided in operation 482 above. As a result, the distraction score for the participant for this video frame may be higher for these multiple weighted anomalies detectable in the current video frame.

In operation 488, the video processing system 320 smooths the distraction scores for each participant. That is, the distraction scores for a given participant may fluctuate significantly over time, whereas smoothing these scores may better indicate whether the participant is distracted for a given time period. Various smoothing techniques may be utilized, such as a simple moving average. In operation 491, the video processing system 320 applies a threshold to the distraction scores for each participant in the current frame to generate a binary score of 0 or 1, whereby 0 indicates a distracted participant, and 1 indicates an engaged participant for the current video frame. The video processing system 320 applies further smoothing to the binary scores for each participant. That is, if a participant 130 is consistently distracted or engaged for a period of time, an occasional frame indicating the opposite may be smoothed over or otherwise discounted to avoid false positives or negatives. The video processing system 320 may store these distraction scores in distraction scoring data 347.

In operation 493, the video processing system 320 determines whether the distraction scores indicate any participants may be distracted. If yes, then processing continues to operation 495. If not, then processing may return in operation 494 to operation 433 of FIG. 4B unless the last frame of the video stream has been sampled, in which case processing may cease for the current video stream. In operation 495, the video processing system 320 may automatically generate an initial notification indicating the distracted participants. The video processing system 320 may provide this initial notification to the presider or other user in real-time, such as through an audible beep from the user interface system, through communication to a wearable device of the presider, etc. Then, in operation 497, the video processing system 320 may generate a video clip(s) showing the distracted participant(s) or supplement prior generated video clip(s). For example, suppose a participant has been distracted for several sampled video frames. In that case, the video processing system 320 may have already captured that prior distraction in a video clip, which now needs to be supplemented. In either case, the sampled frames showing the distracted participant may be stitched together, possibly with other intervening non-sampled frames. These frames may include the bounding box generated during the face detection operations above to indicate which participant has apparently been distracted. Then, in operation 498, the video processing system 320 may provide the video clip(s) to the meeting presider or other users upon request through user interface system 360. Finally, in operation 499, processing may return to operation 433 of FIG. 4B unless the last frame of the video stream has been sampled, in which case processing may cease for the current video stream.

FIGS. 5A and 5B depict block diagrams of global and local dataframes utilized by the video monitoring and distraction analysis and notification system 300 for tracking participant features in space and time, in which various embodiments of the present disclosure may be implemented. FIG. 5A depicts a block diagram 500 of a global dataframe 505 of the faces for all participants in a single sampled video frame N. In the depicted example, this is frame N. For illustrative purposes, each row and column includes a header describing the type of data that row and column include. In the depicted example, frame N includes detected and extracted values for selected features, including valence 510, arousal 512, EAR 514, smile 516, eye gaze pitch 518, and eye gaze yaw 519. Additional features may be included. These detected and extracted feature values are included for face 1, face 2, and face 3, corresponding to a first participant, a second participant, and a third participant. Additional participant's faces may be included. Because these feature values are included for all participants in a single sampled frame, the resulting values are for a single point in time across space. Additional global dataframes from prior sampled video frames may be stored in memory.

FIG. 5B depicts a block diagram 550 of local dataframes 555 and 556 for the faces of all participants in all sampled video frames. In the depicted example, local dataframe 555 includes feature values for face 1 corresponding to a first participant across multiple frames. Dataframe 555 includes detected and extracted values for selected features, including valence 560, arousal 562, EAR 564, smile 566, eye gaze pitch 568, and eye gaze yaw 569 for each frame 1 through N for face 1. Additional features may be included. Dataframe 556 includes detected and extracted values for the same set of detected and extracted features for face 2 corresponding to a second participant across N frames 1 through N. Additional local dataframes may be included for additional participants. Because these feature values are included for all participants across all sampled frames, the resulting values are for a period of time from the start of the video monitoring session to the last sampled video frame. It should be noted that the values of frame N for face 1 of local dataframe 555 are the same as those of face 1 for frame N of global dataframe 505.

FIGS. 6A and 6B depict illustrations of participant features derived from detected participant features by the video processing system 320. Video processing system 320 may derive or otherwise extract a variety of participant facial and bodily features from detected participant features detected by face detection software 351 for each monitored participant. The video processing system 320 utilizes the features to specifically identify and distinguish individuals of the participants 130 and detect anomalies indicating that the individual may be distracted, such as eyes closed other than blinking or head down.

FIG. 6A depicts an open participant eye 610 and a closed participant eye 620 with points P1 through P6 identified. Video processing system 320 may utilize face detection software 351 to detect an XY coordinate value for points P1 through P6 for each participant eye. In the present example, the face detection software detects and locates points P1 and P4 at the inside and outside corner of each eye 610 and 620, points P2 and P3 equidistantly along the top eyelid, and points P5 and P6 equidistantly along the bottom eyelid. To determine each eye aspect ratio (EAR), video processing system 320 determines the distance between P2 and P6, adds that to the distance between P3 and P5, and divides that sum by the distance between P1 and P4. The video processing system 320 may calculate a distance between points by counting pixels, by utilizing XY coordinates of each point, or through other techniques known to those of ordinary skill in the art. Typically, an open eye has a greater eye aspect ratio than a closed eye. As a result, the video processing system 320 may compare the eye aspect ratios of a given participant eye over multiple sampled video frames to determine when the participant's eyes are open or closed. If a participant's eyes are closed across several video frames, then the participant may be distracted or otherwise not paying attention. The video processing system 320 may identify such closed eyes over multiple video frames as an anomaly in operation 479 above.

FIG. 6B depicts an apparent emotion wheel 650 illustrating valence and arousal values for various detected participant emotions. Video processing system 320 may utilize face detection software 351 to detect an apparent emotion of each participant. The video processing system 320 may then utilize the detected apparent emotion of each participant to assign or otherwise extract a valence value 660 and an arousal value 670 for each participant in a given video frame. Valence values are directed to the positivity or negativity of participant's apparent emotions. For example, the video processing system 320 may assign a strongly positive valence value to a happy emotion and may assign a strongly negative valence value to a disgust emotion. Arousal values are directed to the intensity of a participant's apparent emotions. For example, the video processing system 320 may assign a strongly positive arousal value to a fear emotion and may assign a strongly negative arousal value to a bored emotion. The video processing system 320 may then utilize these extracted valence and arousal values to detect anomalies in operation 479 above. For example, the video processing system 320 may determine that a bored participant with eyes closed in a given sampled video frame may be an anomaly, indicating the participant may be distracted.

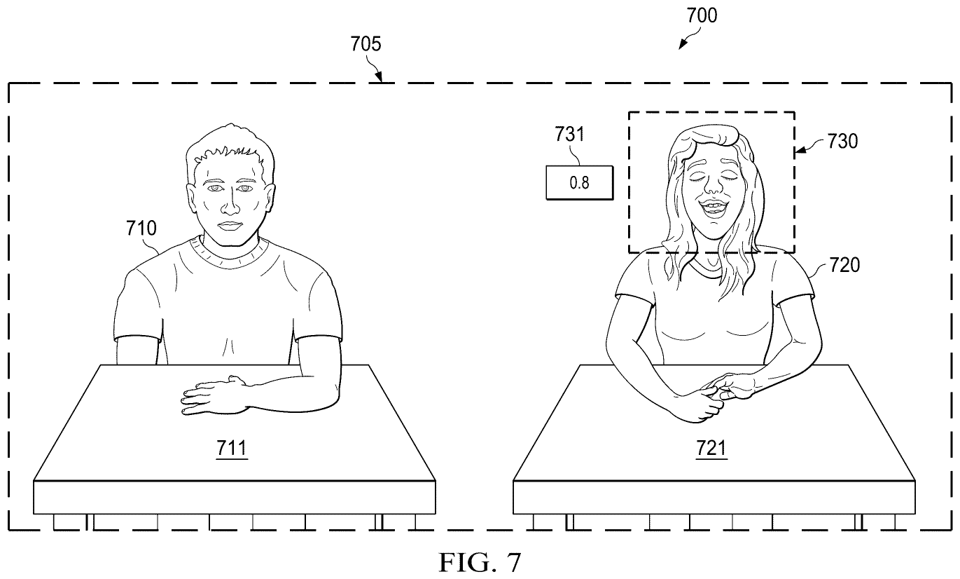

FIG. 7 depicts a single frame 700 of a video clip providing notification of a distracted participant in meeting area 705, in which various embodiments of the present disclosure may be implemented. For simplicity, FIG. 7 depicts two participants 710 and 720 sitting at desks 711 and 721 from the viewpoint of a camera in the meeting area. Alternative examples may include many additional participants in a monitored meeting area. In this video clip frame, participant 720 is distracted, as indicated by bounded set of pixels 730 and a distraction score of 0.8, indicating an 80 percent probability of distraction. In this depiction, participant 710 has open eyes and a closed mouth indicating engagement whereas participant 720 has closed eyes and an open mouth indicating distraction. Video processing system 320 may combine this video frame with other video frames of the distracted participant to provide a video clip showing the distracted participant over time. The video processing system 320 may also include additional frames before and after the period of distraction to provide context. The video processing system 320 may provide this video clip to a presider, administrator, or other user through user interface 362 as a notification of the participant's distraction. The video processing system 320 may also provide additional data with the notification, such as a timestamp or other relevant information.

Alternatively, video processing system 320 may provide each sampled video frame in real-time on user interface system 360 to the presider or other user through user interface 362. The video processing system 320 may include bounded box 730 around each participant's face with a colored distraction score. A red distraction score would indicate that the participant is distracted. A green distraction score would indicate that the participant is not distracted. Other colors or other indications of distraction may be included. The presider or other user may view this real-time sequence of sampled video frames with bounded boxes, distraction scores, and other indications of distraction through user interface 362 as desired. The presider or other user may then utilize this provided video to take appropriate operations to benefit the distracted participants, such as follow-up tutoring or other remediation.

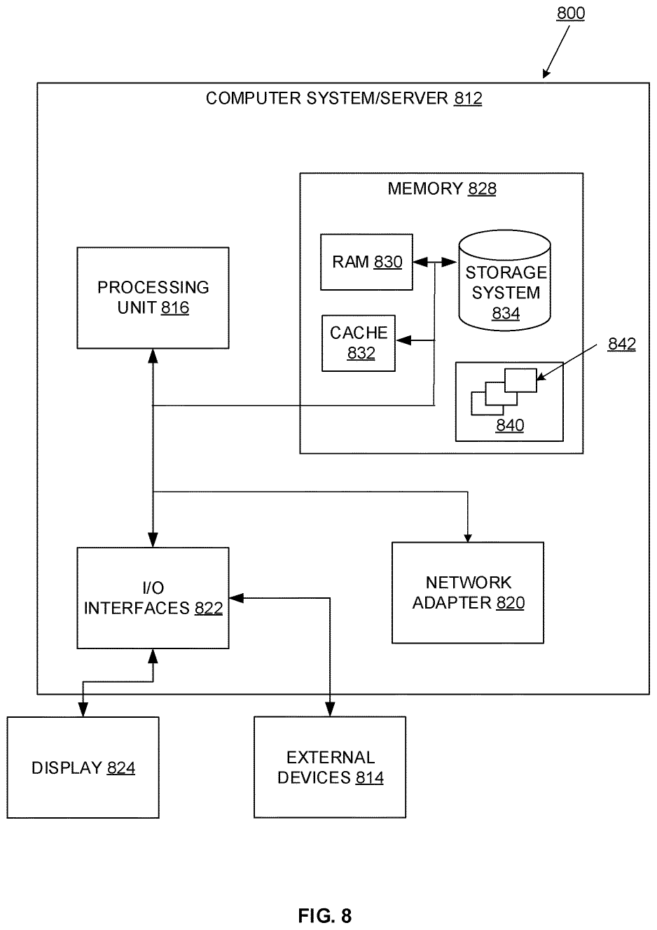

FIG. 8 depicts a block diagram of an illustrative data processing system in which various embodiments of the present disclosure may be implemented. Data processing system 800 is one example of a suitable data processing system and is not intended to suggest any limitation regarding the scope of use or functionality of the embodiments described herein. Regardless, data processing system 800 implement and/or perform any of the functionality set forth herein, such as automated real-time meeting area video monitoring and notification with spatial and temporal analysis to detect participant engagement and distraction.

In data processing system 800, there is a computer system/server 812, which is operational with numerous other computing system environments, peripherals, or configurations. Examples of well-known computing systems, environments, and/or configurations that may be suitable for use with computer system/server 812 include, but not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 812 operates as a specialized machine that could not otherwise perform the processes or implement video monitoring and distraction analysis and notification system 300 without operating in accordance with system and processes described herein. Operations the of computer system/server 812 can be implemented as executable code, such as program modules, being processed by a computer system. Generally, program modules may include routines, programs, objects, components, logic, data structures, and so on that perform particular tasks or implement particular abstract data types. Computer system/server 812 may be practiced in distributed computing environments where tasks are performed by remote processing devices that are linked through a communications network. In a distributed computing environment, program modules may be located in both local and remote computer system storage media, including memory storage devices. For example, various embodiments of the systems and methods described herein may be implemented in a cloud computing environment, distributed or otherwise, which may be virtualized, such as with the use of a hypervisor managing multiple nodes, including virtual processors, virtual memory, etc.

As depicted in FIG. 8, computer system/server 812 in data processing system 800 is shown in the form of a general-purpose computing device. The components of computer system/server 812 may include, but are not limited to, one or more processors or processing units 816, a system memory 828, and a bus 818 that couples various system components, including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnects (PCI) bus.

Computer system/server 812 typically includes a variety of non-transitory computer system usable media. Such media may be any available media that is accessible by computer system/server 812, and it includes both volatile and non-volatile media, removable and non-removable media.

System memory 828 may include non-transitory computer system readable media in the form of volatile memory, such as random access memory (RAM) 830 and/or cache memory 832. Computer system/server 812 may further include other non-transitory removable/non-removable, volatile/non-volatile computer system storage media. By way of example, storage system 834 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”) and an optical disk drive for reading from or writing to a removable, non-volatile optical disk such as a CD-ROM, DVD-ROM or other optical media can be provided. Each type of memory can be connected to bus 818 by one or more data media interfaces. Memory 828 may include at least one program product having a set (e.g., at least one) of program modules that are configured to carry out the functions of the embodiments. Memory 828 may also include data that a program product will process.

Program/utility 840, having a set (at least one) of program modules 842, may be stored in memory 828 by way of example, and not limitation, as well as an operating system, one or more application programs, other program modules, and program data. Each of the operating systems, one or more application programs, other program modules, and program data or some combination thereof may include an implementation of a networking environment. Program modules 842 generally carry out the embodiments' functions and/or methodologies. For example, a program module may be software for automated real-time meeting area video monitoring and notification with spatial and temporal analysis to detect participant engagement and distraction.

Computer system/server 812 may also communicate with one or more external devices 814 such as a keyboard, a pointing device, a display 824, etc.; one or more devices that enable a user to interact with computer system/server 812; and/or any devices (e.g., network card, modem, etc.) that enable computer system/server 812 to communicate with one or more other computing devices. Such communication can occur via I/O interfaces 822 through wired connections or wireless connections. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples include but are not limited to, microcode, device drivers, tape drives, RAID systems, redundant processing units, data archival storage systems, external disk drive arrays, etc.

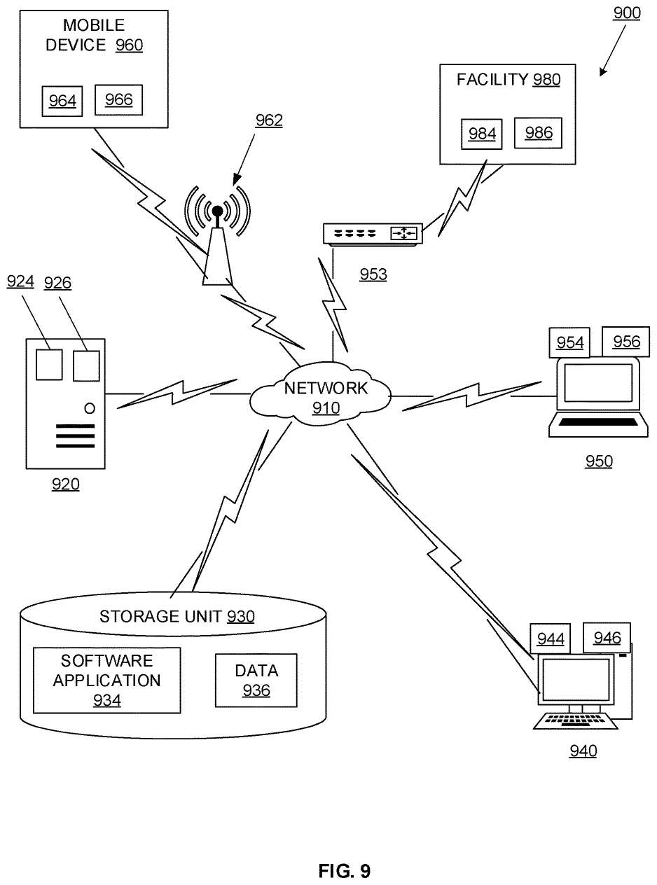

FIG. 9 depicts a block diagram of an illustrative network of data processing systems in which various embodiments of the present disclosure may be implemented. Data processing environment 900 is a network of data processing systems such as described above with reference to FIG. 8. Software applications such as automated real-time meeting area video monitoring and notification with spatial and temporal analysis to detect participant engagement and distraction may be processed on any computer or other type of data processing system in data processing environment 900. Data processing environment 900 includes network 910. Network 910 is the medium used to provide simplex, half duplex, and/or full duplex communications links between various devices and computers connected together within data processing environment 900. Network 910 may include connections such as wire, wireless communication links, or fiber optic cables.

Server 920 and client 940 are coupled to network 910 and storage unit 930. In addition, laptop 950 and facility 980 (such as a home or business) are coupled to network 910 including wirelessly such as through a network router 953. A mobile device 960, such as a mobile phone, may be coupled to network 910 through a cell tower 962. Data processing systems, such as server 920, client 940, laptop 950, mobile device 960, and facility 980 contain data and have software applications including software tools processing thereon. Other types of data processing systems such as personal digital assistants (PDAs), smartphones, tablets, and netbooks may be coupled to network 910.

Server 920 may include software application 924 and data 926 for automated real-time meeting area video monitoring and notification with spatial and temporal analysis to detect participant engagement and distraction or other software applications and data in accordance with embodiments described herein. Storage 930 may contain software application 934 and a content source such as data 936 for automated real-time meeting area video monitoring and notification with spatial and temporal analysis to detect participant engagement and distraction. Other software and content may be stored on storage 930 for sharing among various computers or other data processing devices. Client 940 may include software application 944 and data 946. Laptop 950 and mobile device 960 may also include software applications 954 and 964 and data 956 and 966. Facility 980 may include software applications 984 and data 986 on local data processing equipment. Other types of data processing systems coupled to network 910 may also include software applications. Software applications could include a web browser, email, or other software application for automated real-time meeting area video monitoring and notification with spatial and temporal analysis to detect participant engagement and distraction.

Server 920, storage unit 930, client 940, laptop 950, mobile device 960, facility 980, and other data processing devices may couple to network 910 using wired connections, wireless communication protocols, or other suitable data connectivity. Client 940 may be, for example, a personal computer or a network computer.

In the depicted example, server 920 may provide data, such as boot files, operating system images, and applications to client 940 and laptop 950. Server 920 may be a single computer system or a set of multiple computer systems working together to provide services in a client-server environment. Client 940 and laptop 950 may be clients to server 920 in this example. Client 940, laptop 950, mobile device 960 facility 980, or some combination thereof may include their own data, boot files, operating system images, and applications. Data processing environment 900 may include additional servers, clients, and other devices that are not shown.

In the depicted example, data processing environment 900 may be the Internet. Network 910 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 900 also may be implemented as a number of different types of networks, such as an intranet, a local area network (LAN), or a wide area network (WAN). FIG. 9 is intended as an example and not as an architectural limitation for the different illustrative embodiments.

Among other uses, data processing environment 900 may be used for implementing a client-server environment in which the embodiments may be implemented. A client-server environment enables software applications and data to be distributed across a network such that an application functions by using the interactivity between a client data processing system and a server data processing system. Data processing environment 900 may also employ a service-oriented architecture where interoperable software components distributed across a network may be packaged together as coherent business applications.

Embodiments of the system and method for automated real-time meeting area video monitoring and notification with spatial and temporal analysis to detect participant engagement and distraction may be implemented in any manner, including as a computer program product at any possible technical detail level of integration. The computer program product may include a computer readable storage medium (or media) having computer readable program instructions thereon for causing a processor to carry out aspects of the embodiments of the system and method for automated real-time meeting area video monitoring and notification with spatial and temporal analysis to detect participant engagement and distraction.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present system and method may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry, including, for example, programmable logic circuitry, field-programmable gate arrays (FPGA), or programmable logic arrays (PLA), may process the computer readable program instructions by utilizing state information of the computer readable program instructions to personalize the electronic circuitry, in order to perform aspects of the system and method for automated real-time meeting area video monitoring and notification with spatial and temporal analysis to detect participant engagement and distraction.

Aspects of the present system and method are described herein with reference to flowchart illustrations and/or block diagrams of methods, apparatus (systems), and computer program products. It will be understood that each block of the flowchart illustrations and/or block diagrams and combinations of blocks in the flowchart illustrations and/or block diagrams can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other devices to cause a series of operations to be performed on the computer, other programmable apparatus or other devices to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present system and method. In this regard, each block in the flowchart or block diagrams may represent a module, segment, or portion of instructions comprising one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable and readable. A data storage medium associated with a server data processing system may contain computer usable code such as for automated real-time meeting area video monitoring and notification with spatial and temporal analysis to detect participant engagement and distraction. A client data processing system may download that computer usable code, such as for storing on a data storage medium associated with the client data processing system or for use in the client data processing system. The server data processing system may similarly upload computer usable code from the client data processing system, such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, remote printers, or storage devices through intervening private or public networks. Modems, cable modems, and Ethernet cards are just a few of the currently available types of network adapters.

The descriptions of the various embodiments of the present system and method have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or operations plus function elements in the claims below are intended to include any structure, material, or act for performing the function in combination with other claimed elements as specifically claimed. The description of the present system and method has been presented for purposes of illustration and description but is not intended to be exhaustive or limited to the system and method for automated real-time meeting area video monitoring and notification with spatial and temporal analysis to detect participant engagement and distraction in the form disclosed. Many modifications and variations will be apparent to those of ordinary skill in the art. The embodiment was chosen and described in order to best explain the principles of the system and method and the practical application and to enable others of ordinary skill in the art to understand the system and method for various embodiments with various modifications as are suited to the particular use contemplated.

What is claimed is:

1. A method of monitoring video of a meeting area for distracted participants, the method comprising:
executing code by a data processing system to perform operations comprising:
accessing a stream of video data of a set of participants in a meeting area;
automatically sampling video frames of the stream of video data;
automatically detecting a set of features of each of the set of participants in the sampled video frames;
counting a number of sampled video frames;
generating a prompt to guide an AI system to detect anomalies in the video frames indicating a distracted participant, wherein the prompt includes specific guidance to that directs the AI system to detect features of specific anomalies;
utilizing at least the AI system guided by the prompt, automatically identifying participant distraction related anomalies in the set of features including anomalies in each sampled video frame and anomalies across multiple sampled video frames, wherein the anomalies indicate that each participant associated with the anomalies is distracted from engaging in a particular task;
automatically weighting each of the identified anomalies based on the counted number of sampled video frames;
automatically generating a cumulative distraction score for each participant associated with the anomalies for each of the sampled video frames based on the weighted anomalies;
automatically determining whether the distraction score for each participant associated with the anomalies exceeds a threshold indicating that the participant is distracted; and
automatically providing a notification of each distracted participant to an administrator device.

2. The method of claim 1 wherein automatically sampling, detecting, repeating, identifying, weighting, generating, determining and notifying are performed in real-time.

3. The method of claim 1 wherein executing the code by the data processing system causes the data processing system to perform further operations comprising:
automatically comparing an image of the participants in the sampled video frame to a previously generated database of participant images to identify each of the participants in the meeting area; and
automatically associating the set of features with the identified participants, wherein the provided notification of each distracted participant includes automatically identifying each distracted participant.

4. The method of claim 3 wherein executing the code by the data processing system causes the data processing system to perform further operations comprising:
automatically tracking each of the identified participants across multiple sampled video frames.

5. The method of claim 1 wherein executing the code by the data processing system causes the data processing system to perform further operations comprising:
automatically extracting a set of features for each of the set of participants in the sampled video frame, wherein automatically identifying anomalies includes automatically identifying anomalies from the set of identified features and the set of extracted features for each of the participants.

6. The method of claim 1 wherein executing the code by the data processing system causes the data processing system to perform further operations comprising:
automatically smoothing the cumulative distraction scores for each of the participants across the sampled video frames.

7. The method of claim 1 wherein automatically identifying participant distraction related anomalies utilizes Isolation Forest methodology for detecting distraction related anomalous features that do not follow established patterns in the set of identified and extracted features for the participants.

8. A non-transitory, computer program product for monitoring video of a meeting area for distracted participants, the computer program product comprising a computer readable storage medium having program instructions embodied therewith, the program instructions processed by a processing circuit to cause the device to perform a method comprising the operations of:
accessing a stream of video data of a set of participants in a meeting area;
automatically sampling video frames of the stream of video data;
automatically detecting a set of features of each of the set of participants in the sampled video frames;
counting a number of sampled video frames;
generating a prompt to guide an AI system to detect anomalies in the video frames indicating a distracted participant, wherein the prompt includes specific guidance to that directs the AI system to detect features of specific anomalies;
utilizing at least the AI system guided by the prompt, automatically identifying participant distraction related anomalies in the set of features including anomalies in each sampled video frame and anomalies across multiple sampled video frames, wherein the anomalies indicate that each participant associated with the anomalies is distracted from engaging in a particular task;
automatically weighting each of the identified anomalies based on the counted number of sampled video frames;
automatically generating a cumulative distraction score for each participant associated with the anomalies for each of the sampled video frames based on the weighted anomalies;
automatically determining whether the distraction score for each participant associated with the anomalies exceeds a threshold indicating that the participant is distracted; and
automatically providing a notification of each distracted participant to an administrator device.

9. The computer program product of claim 8 wherein automatically sampling, detecting, repeating, identifying, weighting, generating, determining and notifying are performed in real-time.

10. The computer program product of claim 8 wherein processing the program instructions by the processing circuit causes the circuit to perform further operations comprising: automatically comparing an image of the participants in the sampled video frame to a previously generated database of participant images to identify each of the participants in the meeting area; and automatically associating the set of features with the identified participants, wherein the provided notification of each distracted participant includes automatically identifying each distracted participant.

11. The computer program product of claim 10 wherein processing the program instructions by the processing circuit causes the circuit to perform further operations comprising: automatically tracking each of the identified participants across multiple sampled video frames.

12. The computer program product of claim 8 wherein processing the program instructions by the processing circuit causes the circuit to perform further operations comprising: automatically extracting a set of features for each of the set of participants in the sampled video frame, wherein automatically identifying anomalies includes automatically identifying anomalies from the set of identified features and the set of extracted features for each of the set of participants.

13. The computer program product of claim 8 wherein processing the program instructions by the processing circuit causes the circuit to perform further operations comprising: automatically smoothing the cumulative distraction scores for each of the participants across the sampled video frames.

14. The computer program product of claim 8 wherein automatically identifying participant distraction related anomalies utilizes Isolation Forest tree-based methodology for detecting distraction related anomalous features that do not follow established patterns in the set of identified and extracted features for the participants.

15. A data processing system for monitoring video of a meeting area for distracted participants, the data processing system comprising:
one or more processors; and
a memory, coupled to the one or more processors, storing program instructions which when processed by the processor perform the operations of:
accessing a stream of video data of a set of participants in a meeting area;
automatically sampling video frames of the stream of video data;
automatically detecting a set of features of each of the set of participants in the sampled video frames;
counting a number of sampled video frames;
generating a prompt to guide an AI system to detect anomalies in the video frames indicating a distracted participant, wherein the prompt includes specific guidance to that directs the AI system to detect features of specific anomalies;
utilizing at least the AI system guided by the prompt, automatically identifying participant distraction related anomalies in the set of features including anomalies in each sampled video frame and anomalies across multiple sampled video frames, wherein the anomalies indicate that each participant associated with the anomalies is distracted from engaging in a particular task;
automatically weighting each of the identified anomalies based on the counted number of sampled video frames;
automatically generating a cumulative distraction score for each participant associated with the anomalies for each of the sampled video frames based on the weighted anomalies;
automatically determining whether the distraction score for each participant associated with the anomalies exceeds a threshold indicating that the participant is distracted; and
automatically providing a notification of each distracted participant to an administrator device.

16. The data processing system of claim 16 wherein automatically sampling, detecting, repeating, identifying, weighting, generating, determining and notifying are performed in real-time.

17. The data processing system of claim 15 wherein processing the program instructions by the processor causes the processor to perform further operations comprising: automatically comparing an image of the participants in the sampled video frame to a previously generated database of participant images to identify each of the participants in the meeting area; and automatically associating the set of features with the identified participants, wherein the provided notification of each distracted participant includes automatically identifying each distracted participant.

18. The data processing system of claim 17 wherein processing the program instructions by the processor causes the processor to perform further operations comprising: automatically tracking each of the identified participants across multiple sampled video frames.

19. The data processing system of claim 15 wherein processing the program instructions by the processor causes the processor to perform further operations comprising: automatically extracting a set of features for each of the set of participants in the sampled video frame; wherein automatically identifying anomalies includes identifying anomalies from the set of identified features and the set of extracted features for each of the set of participants.

20. The data processing system of claim 15 wherein processing the program instructions by the processor causes the processor to perform further operations comprising: automatically smoothing the cumulative distraction scores for each of the set of participants across the sampled video frames.

21. The data processing system of claim 15 wherein automatically identifying participant distraction related anomalies utilizes Isolation Forest methodology for detecting distraction related anomalous features that do not follow established patterns in the set of identified and extracted features for the participants.
